(19) United States
(12) Patent Application Publication
(10) Pub. No.: US 2024/0369782 A1
(43) Pub. Date: Nov. 7, 2024

(54) OPTICAL MEMBER AND OPTICAL DEVICE

(71) Applicant: Murata Manufacturing Co., Ltd., Nagaokakyo-shi (JP)

(72) Inventors: Yuji MIURA, Nagaokakyo-shi (JP); Yasuhiro SHIMIZU, Nagaokakyo-shi (JP); Masaki NAGATA, Nagaokakyo-shi (JP); Naoya MORI, Nagaokakyo-shi (JP); Tatsuya TOMIMURA, Nagaokakyo-shi (JP); Kazuho SHIMADA, Nagaokakyo-shi (JP)

(21) Appl. No.: 18/775,101

(22) Filed: Jul. 17, 2024

Related U.S. Application Data
(63) Continuation of application No. PCT/JP2022/040455, filed on Oct. 28, 2022.

(30) Foreign Application Priority Data
Mar. 17, 2022 (JP) 2022-042718

(51) Int. Cl. G02B 6/42

(52) U.S. Cl. CPC G02B 6/4206; G02B 6/4243

(57) ABSTRACT

An optical member that includes: a first optical element including a first medium and a first plurality of fillers in the first medium and having a non-spherical shape that changes a traveling direction of light passing through the first medium; and a holding portion configured to hold an optical fiber such that the light emitted from the first optical element enters an end surface of the optical fiber.

### CROSS REFERENCE TO RELATED APPLICATIONS

The present application is a continuation of International application No. PCT/JP2022/040455, filed Oct. 28, 2022, which claims priority to Japanese Patent Application No. 2022-042718, filed Mar. 17, 2022, the entire contents of each of which are incorporated herein by reference.

### TECHNICAL FIELD

The present invention relates to an optical member and an optical device.

### BACKGROUND ART

As an invention related to a conventional optical member, for example, a semiconductor optical coupling device described in Patent Document 1 has been known. The semiconductor optical coupling device includes a laser diode, an optical isolator, and an optical fiber. The laser diode emits light. Light emitted from the laser diode passes through the optical isolator and enters the end surface of the optical fiber. The optical isolator prevents light reflected by the end surface of the optical fiber or the like from entering the laser diode.
Patent Document 1: Japanese Patent Application Laid-Open No. H11-307872

### SUMMARY OF THE INVENTION

By the way, in the semiconductor optical coupling device described in Patent Document 1, it is desired to reduce the size of the semiconductor optical coupling device and the cost of the semiconductor optical coupling device.

Therefore, an object of the present invention is to provide an optical member and an optical device capable of reducing the size of the optical member and the cost of the optical member.

An optical member according to an embodiment of the present invention includes: a first optical element including a first medium, and a first plurality of fillers in the medium and having a non-spherical shape that changes a traveling direction of light passing through the first medium; and a holding portion configured to hold an optical fiber such that the light emitted from the first optical element enters an end surface of the optical fiber.

According to the present invention, it can be achieved to reduce the size of the optical member and the cost of the optical member.

### BRIEF EXPLANATION OF THE DRAWINGS

FIG. 1 is a perspective view of an optical member 10.

FIG. 2 is a top view of an optical member 10.

FIG. 3 is a transparent view of an optical device 1.

FIG. 4 is an exploded view of an optical device 1.

FIG. 5 is a view of a lens portion 14 as viewed in the negative direction of the X-axis.

FIG. 6 is a transparent view of an optical device 1001.

FIG. 7 is a transparent view of an optical device 1a.

FIG. 8 is a transparent view of an optical device 1b.

FIG. 9 is a perspective view of a gradient index lens 140.

FIG. 10 is a perspective view of a gradient index lens 142.

FIG. 11 is a transparent view of gradient index lenses 14a to 14e of an optical member 10c.

### DETAILED DESCRIPTION OF THE INVENTION

### Embodiment

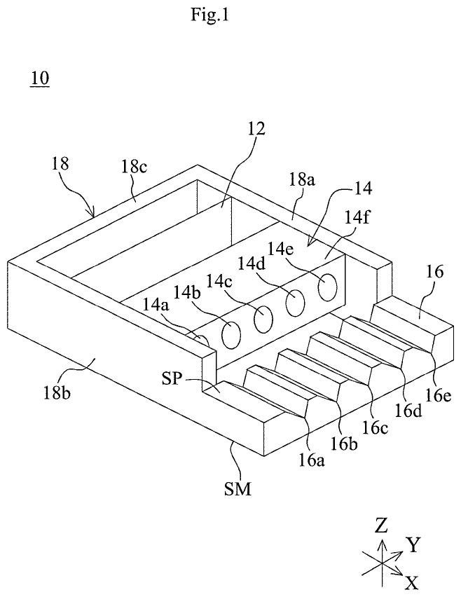

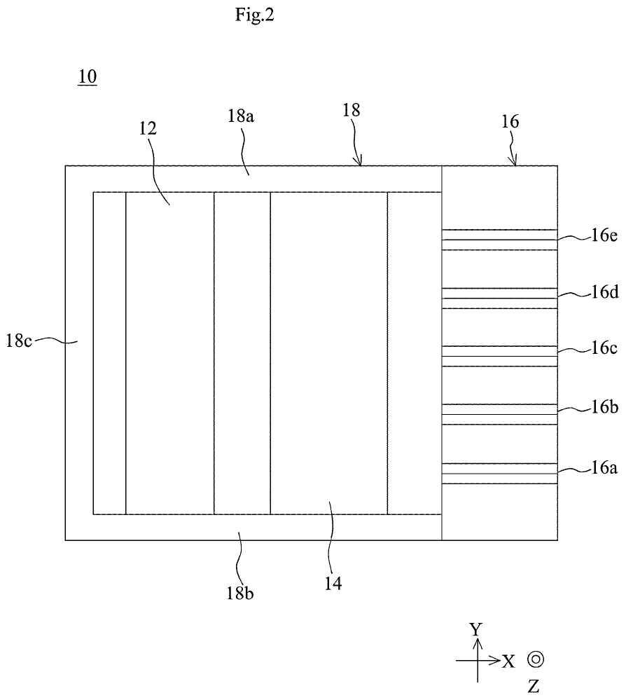

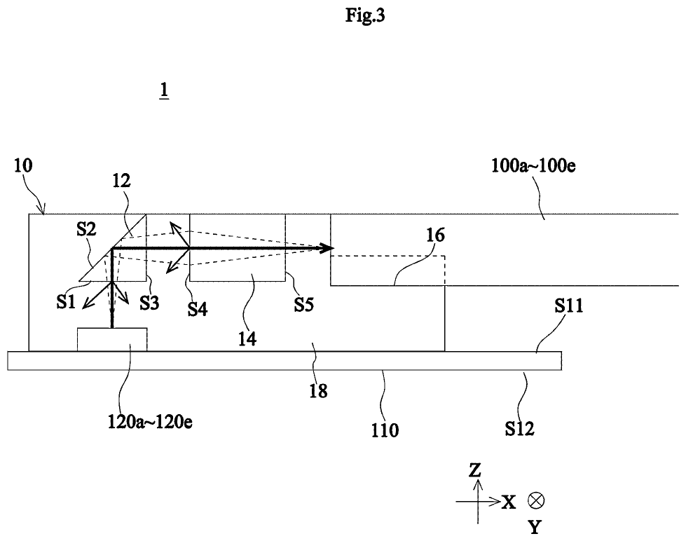

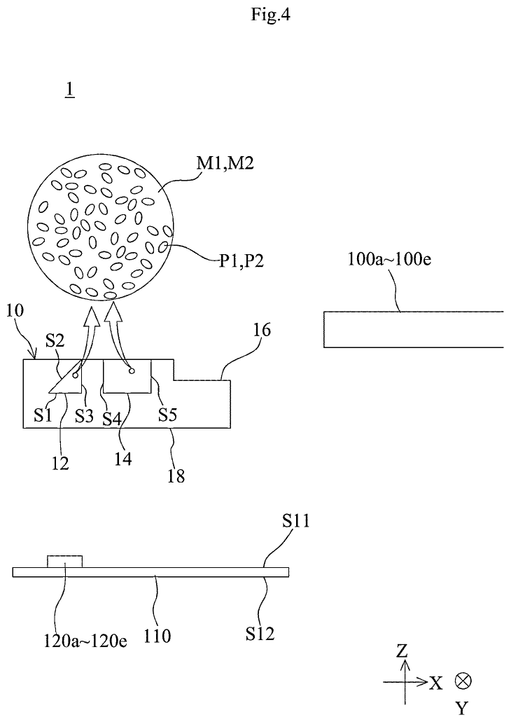

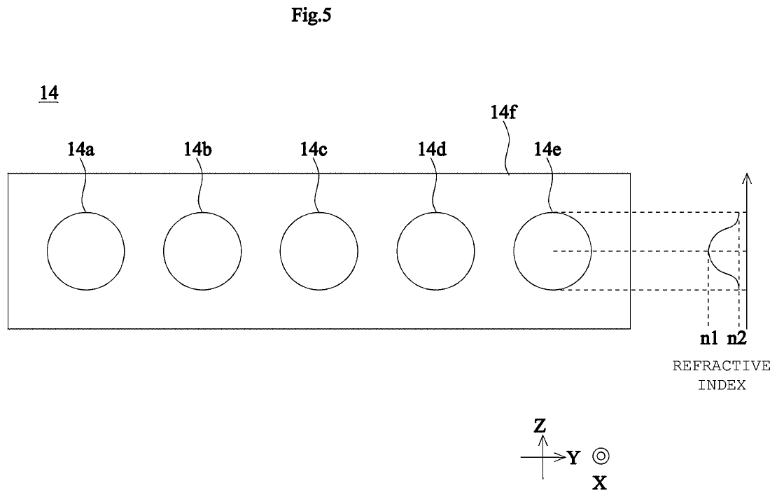

Hereinafter, an optical device 1 including an optical member 10 according to an embodiment of the present invention will be described with reference to the drawings. FIG. 1 is a perspective view of the optical member 10. FIG. 2 is a top view of the optical member 10. FIG. 3 is a transparent view of the optical device 1. FIG. 4 is an exploded view of the optical device 1. FIG. 5 is a view of a lens portion 14 as viewed in the negative direction of the X-axis.

In the present specification, directions are defined as follows. As illustrated in FIG. 3, the direction in which light emitting elements 120a to 120e emit light is defined as the positive direction of the Z-axis. The direction in which light reflected by a prism 12 travels is defined as the positive direction of the X-axis. The direction in which optical fibers 100a to 100e are arranged is defined as the positive direction of the Y-axis. The X-axis, the Y-axis, and the Z-axis are orthogonal to each other. In addition, the X-axis, the Y-axis, and the Z-axis in the present embodiment do not have to coincide with the X-axis, the Y-axis, and the Z-axis in a case where the optical device 1 is used.

The optical device 1 is a transmission device of an optical communication system. As illustrated in FIGS. 3 and 4, the optical device 1 includes an optical member 10, optical fibers 100a to 100e, a circuit board 110, and light emitting elements 120a to 120e.

The optical member 10 has a function of forming an optical path, a function of concentrating light, and a function of changing a traveling direction of light. More specifically, as illustrated in FIGS. 1 and 2, the optical member 10 includes a prism 12, a lens portion 14, a holding portion 16, and a frame 18.

As illustrated in FIGS. 3 and 4, the prism 12 is a second optical element including a medium M2, and a plurality of fillers P2 provided in the medium M2 and having a non-spherical shape. The prism 12 changes a traveling direction of light passing through the medium M2. Specifically, the prism 12 has a right-angled isosceles triangle shape when viewed in the Y-axis direction. The prism 12 has an incident surface S1 to which light enters, a reflection surface S2 on which light is reflected, and an emission surface S3 from which light is emitted. The incident surface S1 has a normal line extending in the negative direction of the Z-axis. The reflection surface S2 has a normal line extending in the positive direction of the Z-axis and the negative direction of the X-axis. The emission surface S3 has a normal line extending in the positive direction of the X-axis.

The medium M2 of the prism 12 is glass. Glass is a material that is amorphous and exhibits a glass transition phenomenon. Examples of the glass include glass of simple oxides such as SiO₂, B₂O₃, P₂O₅, GeO₂, and As₂O₃, glass of silicates such as Li₂O—SiO₂, Na₂O—SiO₂, and K₂O—SiO₂, glass of aluminosilicates such as Na₂O—Al₂O₃—SiO₂ and CaO—Al₂O₃—SiO₂, glass of borates such as LiO₂—Ba₂—O₃ and Na₂O—B₂O₃, glass of aluminoborates such as CaO—Al₂O₃—B₂O₃, and glass of borosilicates such as Na₂O—Al₂O₃—B₂O₃—SiO₂.

The plurality of fillers P2 are metal oxide particles such as crystalline silica, amorphous silica, alumina, magnesium oxide, and titanium oxide. The refractive index of the plurality of fillers is a value between the upper limit value n1 and the lower limit value n2 of the refractive index of the medium M2 of the prism 12 (second optical element). However, in order to suppress reflection due to a difference in refractive index at the interface, it is preferable that the refractive index of the plurality of fillers P2 is close to the refractive index of the medium M2. In addition, it is preferable that the higher the amorphous property of the plurality of fillers P2 is, the higher the permeability of the plurality of fillers P2 is.

The plurality of fillers P2 have a non-spherical shape. The non-spherical shape is a shape that is not a sphere. The shape that is not a sphere is a shape in which the distance from the center to the outer edge is not constant, and is, for example, a rectangular parallelepiped shape or an elliptical spherical shape. The non-spherical shape may be a shape in which a large number of irregularities are provided on the surface of a sphere. In the present embodiment, the plurality of fillers P2 have an elliptical spherical shape. The plurality of fillers P2 have a longitudinal direction and a short direction. The longitudinal direction is a length direction of the longest portion of the plurality of fillers P2. The short direction is a length direction of the shortest portion of the plurality of fillers P2 in the direction orthogonal to the longitudinal direction. The longitudinal direction of the plurality of fillers P2 has a length of L1. The short direction of the plurality of fillers P2 has a length of L2. The light has a wavelength of λ. At this time, L2/L1>L1/λ is satisfied. L1 and L2 are average values of 20 fillers within the plurality of fillers P2 included in the prism 12.

The plurality of fillers P2 are uniformly dispersed throughout the prism 12. Thus, the plurality of fillers P2 are provided on a path of light. In particular, the plurality of fillers P2 are provided at the incident surface S1.

As illustrated in FIG. 1, the lens portion 14 includes gradient index lenses 14a to 14e and a supporting portion 14f. The gradient index lenses 14a to 14e are arranged in this order in the positive direction of the Y-axis. Since the structures of the gradient index lenses 14a to 14e are the same as each other, the gradient index lens 14a will be described as an example.

The gradient index lens 14a has a cylindrical shape having a center axis extending in the front-rear direction. As illustrated in FIG. 3, the gradient index lens 14a has an incident surface S4 and an emission surface S5. The incident surface S4 and the emission surface S5 are arranged in this order in the positive direction of the X-axis. The incident surface S4 has a normal line extending in the negative direction of the X-axis. The emission surface S5 has a normal line extending in the positive direction of the X-axis.

As illustrated in FIG. 4, the gradient index lens 14a is a first optical element including a medium M1, and a plurality of fillers P1 provided in the medium M1 and having a non-spherical shape. The gradient index lens 14a changes a traveling direction of light passing through the medium M1. Specifically, as illustrated in FIG. 5, the refractive index of the gradient index lens 14a decreases with distance from the center axis of the gradient index lens 14a as viewed in the X-axis direction. As a result, as illustrated in FIG. 3, the gradient index lens 14a concentrates light traveling in the positive direction of the X-axis in the medium M1 at a focal point located on the center axis of the gradient index lens 14a. The focal point is located on the positive side of the X-axis with respect to the emission surface S5. As a result, the gradient index lens 14a can change the diameter of light.

The medium M1 of the gradient index lens 14a is glass. Glass is a material that is amorphous and exhibits a glass transition phenomenon. Examples of the glass include glass of simple oxides such as SiO₂, B₂O₃, P₂O₅, GeO₂, and As₂O₃, glass of silicates such as Li₂O—SiO₂, Na₂O—SiO₂, and K₂O—SiO₂, glass of aluminosilicates such as Na₂O—Al₂O₃—SiO₂ and CaO—Al₂O₃—SiO₂, glass of borates such as LiO₂—Ba₂—O₃ and Na₂O—B₂O₃, glass of aluminoborates such as CaO—Al₂O₃—B₂O₃, and glass of borosilicates such as Na₂O—Al₂O₃—B₂O₃—SiO₂.

Examples of a method for providing the gradient index lens 14a with a refractive index distribution include a method described below. By impregnating a cylindrical glass with a molten salt, ions in the glass are replaced with ions in the molten salt, and metal ions are permeated into the cylindrical glass.

The plurality of fillers P1 are metal oxide particles such as crystalline silica, amorphous silica, alumina, magnesium oxide, and titanium oxide. The refractive index of the plurality of fillers P1 is a value between the upper limit value n1 and the lower limit value n2 of the refractive index of the medium M1 of the gradient index lens 14a (first optical element). However, in order to suppress reflection due to a difference in refractive index at the interface, it is preferable that the refractive index of the plurality of fillers P1 is close to the refractive index of the medium M1. In addition, it is preferable that the higher the amorphous property of the plurality of fillers P1 is, the higher the permeability of the plurality of fillers P1 is.

The plurality of fillers P1 have a non-spherical shape. Specifically, the plurality of fillers P1 have an elliptical spherical shape. The plurality of fillers P1 have a longitudinal direction and a short direction. The longitudinal direction is a length direction of the longest portion of the plurality of fillers P1. The short direction is a length direction of the shortest portion of the plurality of fillers P1 in the direction orthogonal to the longitudinal direction. The longitudinal direction of the plurality of fillers P1 has a length of L1. The short direction of the plurality of fillers P1 has a length of L2. The light has a wavelength of λ. At this time, L2/L1>L1/λ is satisfied. L1 and L2 are average values of 20 fillers within the plurality of fillers P1 included in the gradient index lens 14a.

The plurality of fillers P1 are uniformly dispersed throughout the gradient index lenses 14a to 14e. Thus, the plurality of fillers P1 are provided on a path of light. In particular, the plurality of fillers P1 are provided at the incident surface S4.

The supporting portion 14f supports the gradient index lenses 14a to 14e. Specifically, the supporting portion 14f has an elliptical spherical shape. The gradient index lenses 14a to 14e are embedded in the supporting portion 14f. However, each of the incident surfaces S4 of the gradient index lenses 14a to 14e is exposed from the surface of the supporting portion 14f on the negative side of the X-axis. Each of the emission surfaces S5 of the gradient index lenses 14a to 14e is exposed from the surface of the supporting portion 14f on the positive side of the X-axis. The material of the supporting portion 14f is the same glass as the medium M1 of the gradient index lens 14a.

The gradient index lenses 14a to 14e as described above are located on the positive side of the X-axis with respect to the prism 12. As a result, the incident surface S4 of the gradient index lenses 14a to 14e overlaps the emission surface S3 of the prism 12 as viewed in the X-axis direction.

As illustrated in FIG. 3, the holding portion 16 holds the optical fibers 100a to 100e such that light emitted from the gradient index lenses 14a to 14e (first optical element) enters the end surfaces T of the optical fibers 100a to 100e, respectively. More specifically, the holding portion 16 is located on the positive side of the X-axis with respect to the lens portion 14. As illustrated in FIG. 1, the holding portion 16 has a plate shape having a positive main surface SP and a negative main surface SM. The positive main surface SP and the negative main surface SM are arranged in this order in the negative direction of the Z-axis. The positive main surface SP of the holding portion 16 is provided with grooves 16a to 16e extending in the X-axis direction. The grooves 16a to 16e are arranged in this order in the positive direction of the Y-axis. Each of the optical fibers 100a to 100e is fixed to the grooves 16a to 16e with an adhesive. At this time, the optical axes of the optical fibers 100a to 100e coincide with the center axes of the gradient index lenses 14a to 14e, respectively. The material of the holding portion 16 is the same glass as the medium M2 of the prism 12 and the medium M1 of the gradient index lens 14a.

The frame 18 supports the prism 12, the lens portion 14, and the holding portion 16. More specifically, the frame 18 includes supporting portions 18a and 18b and a join portion 18c. Each of the supporting portions 18a and 18b is a plate having two main surfaces arranged in the Y-axis direction. The supporting portions 18a and 18b are arranged in this order in the negative direction of the Y-axis. The end of the holding portion 16 on the positive side of the Y-axis and the end of the lens portion 14 on the positive side of the Y-axis are in contact with the supporting portion 18a. The end of the holding portion 16 on the negative side of the Y-axis and the end of the lens portion 14 on the negative side of the Y-axis are in contact with the supporting portion 18b. The surface of the holding portion 16 located on the negative side of the X-axis is in contact with the end of the supporting portion 18a on the positive side of the X-axis direction and the end of the supporting portion 18b on the positive side of the X-axis direction.

The join portion 18c is a plate having two main surfaces arranged in the X-axis direction. The end of the join portion 18c on the positive side of the Y-axis is in contact with the supporting portion 18a. The end of the join portion 18c on the negative side of the Y-axis is in contact with the supporting portion 18b. The material of the holding portion 16 is the same glass as the medium M2 of the prism 12 and the medium M1 of the gradient index lens 14a.

The lens portion 14 (first optical element), the prism 12 (second optical element), the holding portion 16, and the frame 18 as described above are integrally molded. That is, the lens portion 14 (first optical element), the prism 12 (second optical element), the holding portion 16, and the frame 18 can not be separated without being damaged.

As illustrated in FIGS. 3 and 4, the circuit board 110 has a plate shape. Therefore, the circuit board 110 has a positive main surface S11 and a negative main surface S12. The positive main surface S11 is located on the positive side of the Z-axis with respect to the negative main surface S12. The surface and inside of the circuit board 110 is provided with an electric circuit such as wiring. The circuit board 110 is located on the negative side in the Z-axis direction with respect to the optical member 10.

The light emitting elements 120a to 120e emit light in the positive direction of the Z-axis. The light emitting elements 120a to 120e are, for example, vertical cavity surface emitting lasers (VCSEL). The wavelength of the light is, for example, 1310 nm. The light emitting elements 120a to 120e are mounted on the positive main surface S11 of the circuit board 110. The light emitting elements 120a to 120e overlap the incident surface S1 of the prism 12 as viewed in the Z-axis direction.

In the optical device 1 as described above, the light emitting elements 120a to 120e emit light in the positive direction of the Z-axis. At this time, as illustrated in FIG. 3, the light travels in the positive direction of the Z-axis while expanding in diameter in the direction orthogonal to the traveling direction or while maintaining the diameter as it is. Then, the light emitted from the light emitting elements 120a to 120e enters the prism 12 (second optical element) via the incident surface S1. The light travels in the positive direction of the X-axis by being reflected on the reflection surface S2. Then, the light is emitted from the prism 12 via the emission surface S3.

Then, the light emitted from the prism 12 (second optical element) enters the gradient index lenses 14a to 14e (first optical element) via the incident surface S4. The light is concentrated when passing through the gradient index lenses 14a to 14e. Then, the light is emitted from the gradient index lenses 14a to 14e via the emission surface S5. Thereafter, the light enters the optical fibers 100a to 100e.

### Effect

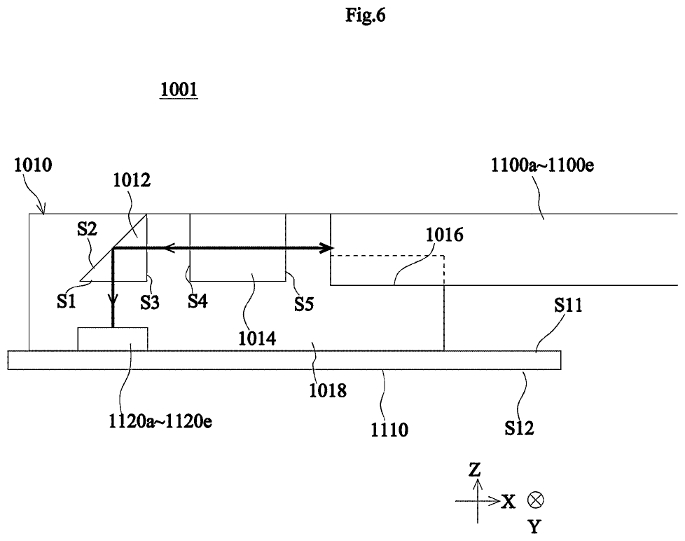

According to the optical member 10, it can be achieved to reduce the size of the optical member 10 and the cost of the optical member 10. Hereinafter, an optical device 1001 according to a comparative example will be described as an example. FIG. 6 is a transparent view of the optical device 1001. The optical device 1001 is different from the optical device 1 in that the prism 1012 does not include the plurality of fillers P2 and that the gradient index lenses 1014a to 1014e (not illustrated) do not include the plurality of fillers P1.

As illustrated in FIG. 6, light is reflected on the incident surfaces S1 and S4. Therefore, the reflected light enters the light emitting elements 120a to 120e. Such reflected light may affect the oscillation states of the light emitting elements 120a to 120e. In order to solve this problem, the semiconductor optical coupling device described in Patent Document 1 includes an optical isolator.

However, since the semiconductor optical coupling device described in Patent Document 1 requires an optical isolator, there are problems of an increased size of the semiconductor optical coupling device and higher cost of the semiconductor optical coupling device.

Therefore, in the optical device 1, the gradient index lenses 14a to 14e include the plurality of fillers P1. The prism 12 includes the plurality of fillers P2. As a result, a part of light is reflected by the plurality of fillers P1 while traveling in the medium M1. Similarly, a part of light is reflected by the plurality of fillers P2 while traveling in the medium M2. Note that the plurality of fillers P1 and P2 have a non-spherical shape. Therefore, the light reflected by the plurality of fillers P1 does not travel in the negative direction of the X-axis as illustrated in FIG. 3. Similarly, the light reflected by the plurality of fillers P2 does not travel in the negative direction of the Z-axis. Therefore, the light reflected by the plurality of fillers P1 and P2 is less likely to enter the light emitting elements 120a to 120e.

As described above, in the optical member 10, by providing the plurality of fillers P1 and P2 without adding a new element, the reflected light is prevented from entering the light emitting elements 120a to 120e. Therefore, it can be achieved to reduce the size of the optical member 10 and the cost of the optical member 10.

In the optical member 10, the plurality of fillers P1 and P2 are provided on a path of light. As a result, light is easily reflected by the plurality of fillers P1 and P2.

In particular, in the optical member 10, the plurality of fillers P1 and P2 are provided at the incident surface S1 and S4. As a result, the light reflected on the incident surface S1 is reflected by the plurality of fillers P2 in a direction other than the negative direction of the Z-axis. Similarly, the light reflected on the incident surface S4 is reflected by the plurality of fillers P1 in a direction other than the negative direction of the X-axis. As a result, the light reflected by the plurality of fillers P1 and P2 is less likely to enter the light emitting elements 120a to 120e.

In the optical member 10, the refractive index of the plurality of fillers P1 is a value between the upper limit value n1 and the lower limit value n2 of the refractive index of the medium M1 of the gradient index lenses 14a to 14e. As a result, it is possible to reduce the influence of the plurality of fillers P1 on the optical characteristics of the gradient index lenses 14a to 14e.

In the optical member 10, when the longitudinal direction of the plurality of fillers P1 and P2 has a length of L1, the short direction of the plurality of fillers P1 and P2 has a length of L2, and the light has a wavelength of λ, L2/L1>L1/λ is satisfied. When A is larger than L1, Rayleigh scattering occurs. A spherical filler has more backscattering components in Rayleigh scattering, which is prevented in a non-spherical filler.

In the optical member 10, the prism 12 and the gradient index lenses 14a to 14e are integrally molded. This suppresses variations in the positional relationship between the prism 12 and the gradient index lenses 14a to 14e.

### (First Modification)

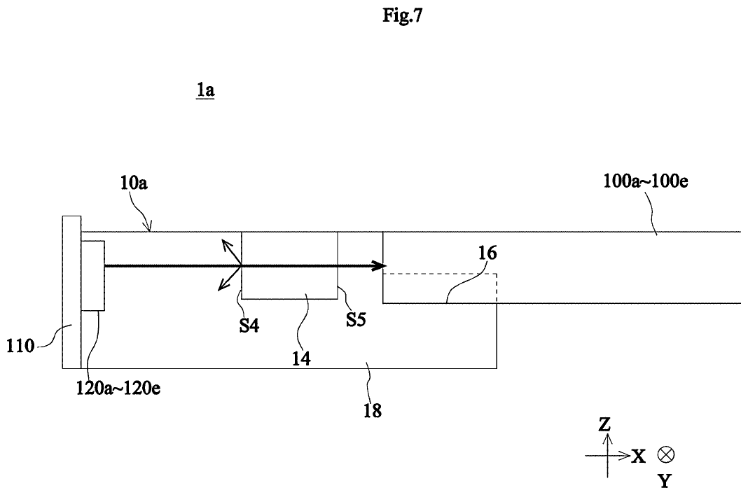

Hereinafter, an optical device 1a including an optical member 10a according to the first modification will be described with reference to the drawings. FIG. 7 is a transparent view of the optical device 1a.

The optical member 10a is different from the optical member 10 in that the prism 12 is not provided. In this case, each of the light emitting elements 120a to 120e is located on the negative side of the X-axis with respect to the gradient index lenses 14a to 14e. Then, light emitted from each of the light emitting elements 120a to 120e enters the gradient index lenses 14a to 14e (first optical element). Other structures of the optical member 10a are the same as those of the optical member 10, and thus description thereof is omitted. With the optical member 10a, it is possible to provide the same action and effect as those of the optical member 10.

### (Second Modification)

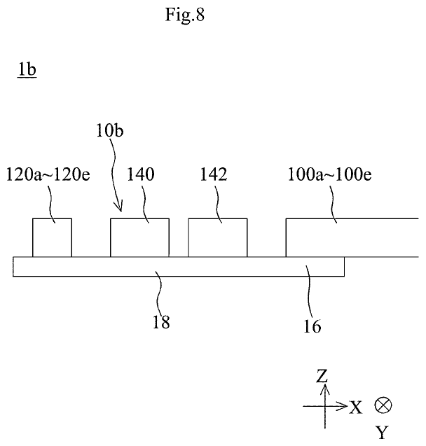

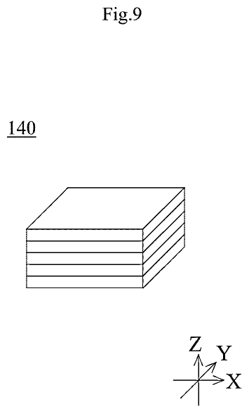

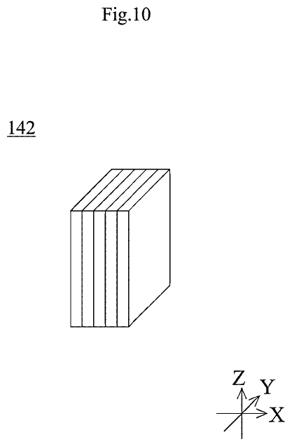

Hereinafter, an optical device 1b including an optical member 10b according to the second modification will be described with reference to the drawings. FIG. 8 is a transparent view of the optical device 1b. FIG. 9 is a perspective view of a gradient index lens 140. FIG. 10 is a perspective view of a gradient index lens 142.

The optical member 10b is different from the optical member 10a in that the gradient index lens 140 (first optical element) and the gradient index lens 142 are provided instead of the gradient index lenses 14a to 14e (first optical element). The refractive index of the gradient index lens 140 decreases with distance from the center of the Z-axis direction to the positive direction or negative direction of the Z-axis direction. As a result, the gradient index lens 140 concentrates light so that the diameter of light traveling in the positive direction of the X-axis decreases in the Z-axis direction. The gradient index lens 140 includes a medium and a plurality of fillers.

The refractive index of the gradient index lens 142 decreases with distance from the center of the Y-axis direction to the positive direction or negative direction of the Y-axis direction. As a result, the gradient index lens 142 concentrates light so that the diameter of light traveling in the positive direction of the X-axis decreases in the Y-axis direction. The gradient index lens 142 includes a medium and a plurality of fillers.

Other structures of the optical member 10b are the same as those of the optical member 10a, and thus description thereof is omitted. With the optical member 10b, it is possible to provide the same action and effect as those of the optical member 10a.

### (Third Modification)

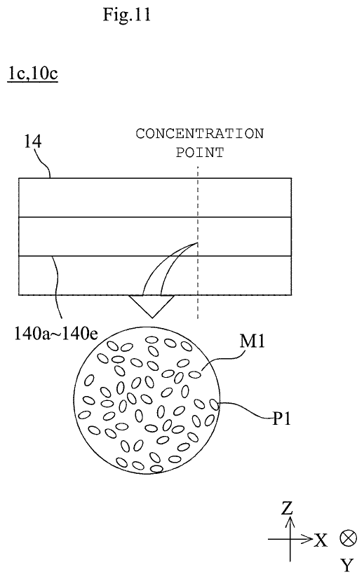

Hereinafter, an optical device 1c including an optical member 10c according to the third modification will be described with reference to the drawings. FIG. 11 is a transparent view of gradient index lenses 14a to 14e of the optical member 10c.

The optical member 10c is different from the optical member 10 in a position where the plurality of fillers P1 is provided. More specifically, the gradient index lenses 14a to 14e have concentration points. The concentration point is a position where light has a smallest diameter in the gradient index lenses 14a to 14e (first optical element). The plurality of fillers P1 are located at the concentration point. Thus, light is effectively scattered by the plurality of fillers P1. Other structures of the optical member 10c are the same as those of the optical member 10, and thus description thereof is omitted. With the optical member 10c, it is possible to provide the same action and effect as those of the optical member 10.

### OTHER EMBODIMENTS

The optical member according to the present invention is not limited to the optical members 10 and 10a to 10c, and can be modified within the scope of the gist thereof. In addition, the structures of the optical members 10 and 10a to 10c may be arbitrarily combined.

Note that the first optical element and the second optical element may be optical elements other than a prism and a gradient index lens.

The plurality of fillers may be provided at positions other than the concentration point. The plurality of fillers does not have to be provided at the concentration point.

The plurality of fillers does not have to be provided at the incident surface.

At this time, L2/L1>L1/λ does not have to be satisfied.

Note that the optical device may include a reception device in addition to the transmission device. That is, the optical device may include a light receiving element in addition to the light emitting element. In this case, the first optical element and the second optical element corresponding to the light emitting element may contain a medium and a plurality of fillers.

Note that the position of the gradient index lens 140 and the position of the gradient index lens 142 may be interchanged.

It is possible that the optical member does not include a gradient index lens but includes a prism. In this case, the prism is the first optical element.

Note that the refractive index of the gradient index lens may change stepwise.

### DESCRIPTION OF REFERENCE SYMBOLS

1, 1a to 1c: Optical device
10, 10a to 10c: Optical member
12: Prism
14: Lens portion
14a to 14e, 140, 142: Gradient index lens
14f: Supporting portion
16: Holding portion
16a to 16e: Groove
18: Frame
18a, 18b: Supporting portion
18c: Join portion
100a to 100e: Optical fiber
110: Circuit board
120a to 120e: Light emitting element
M1, M2: Medium
P1, P2: Filler
S1, S4: Incident surface
S11, SP: Positive main surface
S12, SM: Negative main surface
S2: Reflection surface
S3, S5: Emission surface
T: End surface

1. An optical member comprising:
a first optical element including a first medium and a first plurality of fillers in the first medium and having a non-spherical shape that changes a traveling direction of light passing through the first medium; and
a holding portion configured to hold an optical fiber such that the light emitted from the first optical element enters an end surface of the optical fiber.

2. The optical member according to claim 1, wherein
the first plurality of fillers have a longitudinal direction and a short direction, and
when the longitudinal direction of the first plurality of fillers has a length of L1, the short direction of the first plurality of fillers has a length of L2, and the light has a wavelength of λ, L2/L1>L1/λ.

3. The optical member according to claim 1, wherein the first plurality of fillers are provided on a path of the light.

4. The optical member according to claim 3, wherein the first plurality of fillers are provided at a position where the light has a smallest diameter in the first optical element.

5. The optical member according to claim 1, wherein the first optical element is a gradient index lens, and the first plurality of fillers have a refractive index that is a value between an upper limit value and a lower limit value of a refractive index of the first medium of the first optical element.

6. The optical member according to claim 1, wherein
the first optical element is a prism having an incident surface to which the light enters, a reflection surface on which the light is reflected, and an emission surface from which the light is emitted, and
the first plurality of fillers are provided at the incident surface.

7. The optical member according to claim 1, wherein the optical member further comprises:
a second optical element that is a prism having an incident surface to which the light enters, a reflection surface on which the light is reflected, and an emission surface from which the light is emitted, wherein
the first optical element is a gradient index lens, and the first optical element is positioned such that the light emitted from the second optical element enters the first optical element.

8. The optical member according to claim 7, wherein the first optical element and the second optical element are an integrally molded article.

9. The optical member according to claim 7, wherein the second optical element includes a second medium and a second plurality of fillers in the second medium and having a non-spherical shape that changes a traveling direction of light passing through the second medium.

10. The optical member according to claim 9, wherein
the first plurality of fillers and the second plurality of fillers have a longitudinal direction and a short direction, and
when the longitudinal direction has a length of L1, the short direction has a length of L2, and the light has a wavelength of λ, L2/L1>L1/λ.

11. The optical member according to claim 10, wherein the first plurality of fillers and the second plurality of fillers are provided on a path of the light.

12. The optical member according to claim 11, wherein the first plurality of fillers are provided at a position where the light has a smallest diameter in the first optical element.

13. The optical member according to claim 10, wherein the second plurality of fillers are provided at the incident surface.

14. An optical device comprising:
a light emitting element that emits the light; and
the optical member according to claim 1 positioned such that the light emitted from the light emitting element enters the first optical element.

15. The optical device according to claim 14, wherein the optical device further comprises an optical fiber held on the holding portion.

16. An optical device comprising:
a light emitting element that emits the light; and
the optical member according to claim 7 positioned such that the light emitted from the light emitting element enters the second optical element.

17. The optical device according to claim 16, wherein the optical device further comprises an optical fiber held on the holding portion.
